(19) United States
(12) Patent Application Publication
(10) Pub. No.: US 2017/0082020 A1
(43) Pub. Date: Mar. 23, 2017

(54) Attachment Structure For Engine Accessory

(71) Applicant: SANDEN HOLDINGS CORPORATION, Isesaki-shi (JP)

(72) Inventor: Jiro IIZUKA, Isesaki-shi (JP)

(21) Appl. No.: 15/126,657

(22) PCT Filed: Mar. 16, 2015
(86) PCT No.: PCT/JP2015/057717

§ 371 Date: Sep. 16, 2016

(30) Foreign Application Priority Data
Mar. 18, 2014 (JP) 2014-055100

(51) Int. Cl. F02B 67/06; F16B 5/02; B60H 1/32

(52) U.S. Cl. CPC F02B 67/06; B60H 1/3229; F16B 5/025; B60H 1/3223

(57) ABSTRACT

A structure for smoothly attaching an engine accessory configured to be driven with a belt to an engine body at an appropriate position. A compressor 100 configured to be driven with a belt 3 is fastened by screwing three bolts 8 respectively inserted in a first bolt insertion hole 5 having a complete circular sectional shape with a minimum fitting gap, a second bolt insertion hole 6 having an oval sectional shape in a hole portion near an accessory attachment part 9 and having a complete circular sectional shape with a diameter greater than or equal to a longer diameter of the oval sectional shape in a hole portion reaching a head portion of a corresponding one of the bolts, and a third bolt insertion hole 7 having a complete circular sectional shape with a sufficiently large diameter, into corresponding screw holes 10 in the accessory attachment part 9.

### TECHNICAL FIELD

The present invention relates to an attachment structure for attaching, to an engine body, an engine accessory configured to be driven with a belt.

### BACKGROUND ART

With an attachment structure of this type, an engine accessory such as a power steering or a compressor for an air conditioner is attached to an engine body by fastening with bolts at a plurality of locations, as disclosed in Patent Document 1.

In this attachment structure, however, to set a tension of the belt at an appropriate value after attachment of the accessory, accurate maintenance of the attachment position of the accessory to the engine body is required. In addition, smooth attachment of the accessory is also required while allowing positional variations between screw holes formed in the engine body and bolt insertion holes formed in the accessory.

### REFERENCE DOCUMENT LIST

### Patent Document

Patent Document 1: Japanese Patent Application Laid-open Publication No. 10-184382

### SUMMARY OF THE INVENTION

### Problems to be Solved by the Invention

To satisfy the requirements described above, at least one bolt insertion hole needs to have an oval shape in a cross section perpendicular to an axial direction thereof. In a conventional technique, however, because of various limitations, it takes time for machining a bolt insertion hole satisfying the above requirements, it is difficult to obtain a machining accuracy, and machining costs increase, for example, disadvantageously.

The present invention has an object of easily providing a structure for smoothly attaching an engine accessory configured to be driven with a belt to an engine body at an appropriate position.

### Means for Solving the Problems

To achieve the object, the present invention has a feature of providing an attachment structure for attaching an engine accessory configured to be driven with a belt by screwing bolts penetrating bolt insertion holes in the engine accessory into screw holes in an engine body, wherein at least one of the bolt insertion holes has an oval sectional shape in a cross section perpendicular to an axial direction thereof in a hole portion near a corresponding one of the screw holes and has a complete circular sectional shape with a diameter greater than or equal to a longer diameter of the oval sectional shape in a hole portion continuous to the hole portion with the oval sectional shape and reaching a head portion of a corresponding one of the bolts.

### Effects of the Invention

In the attachment structure for the engine accessory according to the present invention, the hole portion with the oval sectional shape of at least one bolt insertion hole can restrict movement of a bolt in the direction along a shorter diameter of the oval sectional shape with a reduced gap between the shorter diameter and the bolt diameter while allowing variations in a bolt attachment position in the direction along the longer diameter of the oval sectional shape. Thus, the bolt can be smoothly attached to the bolt insertion hole at an appropriate attachment position. Accordingly, the engine accessory can be attached to the engine body at an appropriate position.

In addition, a hole with the oval sectional shape does not need to be formed along the entire length of the bolt insertion hole. Thus, reduction of a machining time, enhancement of a machining accuracy, and reduction of machining costs, for example, can be obtained.

### BRIEF DESCRIPTION OF THE DRAWINGS

FIG. 1 is a front view illustrating a compressor to be attached to an engine body with an attachment structure for an engine accessory according to an embodiment of the present invention.

FIG. 2 is a right side view of the compressor.

FIG. 3 is a cross-sectional view taken along line X-X in FIG. 2.

FIG. 4 is a perspective view illustrating two core pins for use in forming a second bolt insertion hole of the compressor.

FIG. 5 is a cross-sectional view illustrating a front housing of the compressor in a state where through holes are formed by using the core pins.

FIG. 6 is a cross-sectional view illustrating the front housing of the compressor in a state where the second bolt insertion hole is formed.

### MODE FOR CARRYING OUT THE INVENTION

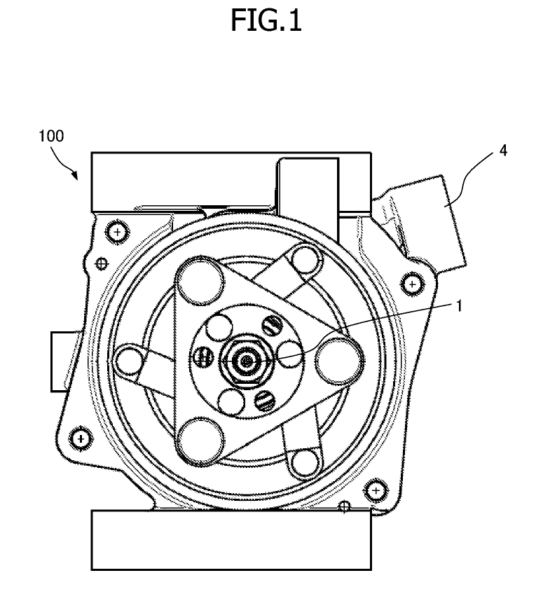

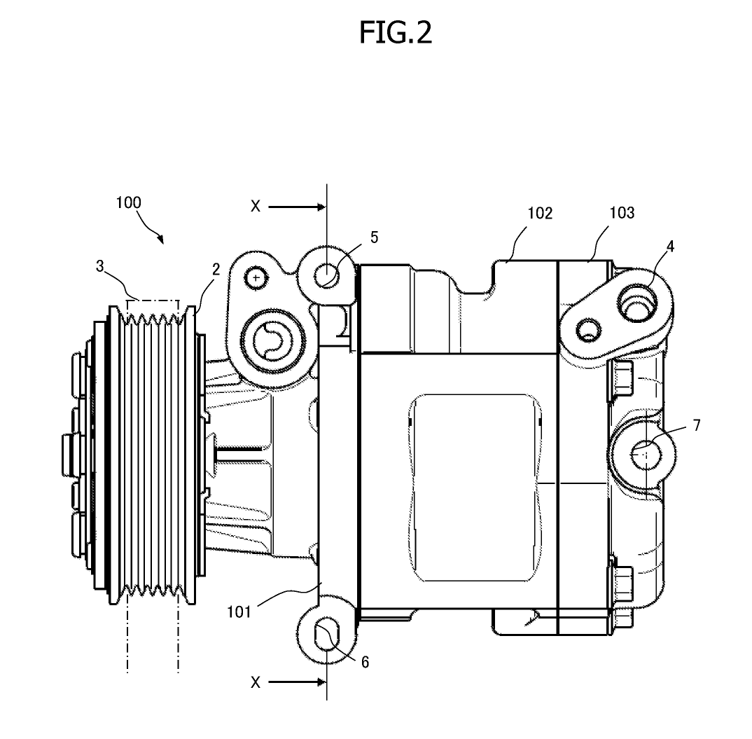

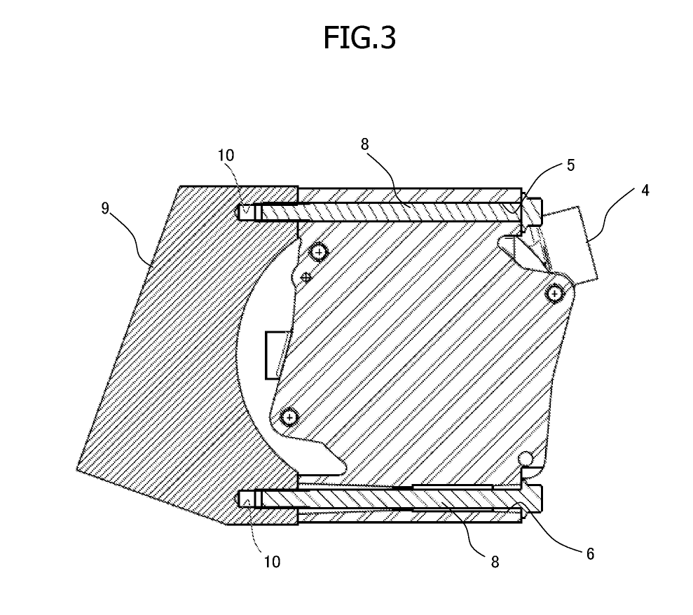

An embodiment of the present invention will be hereinafter described with reference to the drawings. FIGS. 1 and 2 are respectively a front view and a right side view of a compressor for use in an automotive air-conditioning system as an engine accessory that is attached to an engine body with an attachment structure according to the present invention. FIG. 3 is a cross-sectional view taken along line X-X in FIG. 2.

In an illustrated compressor 100, a front housing 101, a center housing 102, and a rear housing 103 are fastened to one another with unillustrated bolts along an axial direction of a driving shaft 1.

A front end of the driving shaft 1 projects forward of the front housing 101, and a pulley 2 is attached to the front end with an unillustrated electromagnetic clutch interposed therebetween.

A belt 3 is looped between the pulley 2 and a driving shaft (crank shaft) of the engine body or a pulley 2 attached to a rotational shaft in cooperation with the driving shaft. In this manner, the driving shaft 1 is driven to rotate by a rotational driving force applied from the pulley 2 through the electromagnetic clutch.

The center housing 102 includes, therein, a pump mechanism having a chamber whose volume changes in accordance with rotation of the driving shaft 1 so that the volume change of the chamber causes a refrigerant gas introduced into the chamber to be compressed and discharged.

The refrigerant gas discharged from the pump mechanism is guided to the outside through a discharge chamber formed in the rear housing 103 and a discharge port 4, and is supplied to an unillustrated heat exchanger (condenser).

The attachment structure of the thus-configured compressor 100 has a configuration as follows.

The front housing 101 includes two upper and lower boss portions extending perpendicularly to the driving shaft 1, and a first bolt insertion hole 5 and a second bolt insertion hole 6 are respectively formed in the two boss portions.

The rear housing 103 also has a third bolt insertion hole 7 formed in a boss portion located at an intermediate height between the two holes, that is, the first bolt insertion hole 5 and the second bolt insertion hole 6, of the front housing 101.

The ends (external thread portions) of the three bolts 8 penetrating the three bolt insertion holes 5 to 7 are screwed and fastened to screw holes 10 formed in an accessory attachment part 9 of the engine body (the engine body or a member such as a bracket coupled to the engine body), thereby attaching the compressor 100 to the engine body.

The three bolt insertion holes 5 to 7 are formed in the following manner.

The upper first bolt insertion hole 5 has a complete circular sectional shape with a minimum fitting gap with the bolt 8 and is straight, that is, has a constant diameter, in the axial direction.

That is, the first bolt insertion hole 5 is set as a reference hole for attachment position in such a manner that the compressor 100 is maintained at an accurate position relative to the engine body while the bolt 8 is screwed into the corresponding screw hole 10 formed in the accessory attachment part 9.

On the other hand, the lower second bolt insertion hole 6 is formed in such a manner that the compressor 100 is maintained at an accurate position relative to the engine body while two bolts 8 are inserted into the first bolt insertion hole 5 and the second bolt insertion hole 6 and screwed into the corresponding screw holes 10 in the accessory attachment part 9, and that the bolts 8 are smoothly screwed into the screw holes 10 with a reduced interference (contact friction resistance) with the second bolt insertion hole 6.

A hole portion of the second bolt insertion hole 6 at an end near the accessory attachment part 9 has an oval shape (oval sectional shape) in a cross section perpendicular to the axial direction (hereinafter simply referred to as a cross section or a sectional shape), and another hole portion of the second bolt insertion hole 6 at the opposite end (near a bolt head portion) has a complete circular shape in a cross section (complete circular sectional shape).

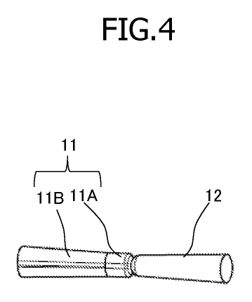

First, in forming the front housing 101 of the compressor 100 by casting, the two hole portions are respectively formed by using a core pin 11 having an oval sectional shape and a core pin 12 having a complete circular sectional shape, as illustrated in FIG. 4.

The oval section core pin 11 includes a straight portion 11A having an end portion with an oval sectional shape extending to a predetermined length in the axial direction and a tapered portion 11B that is tapered to gradually increase an oval-shape cross sectional area thereof from a proximal end of the straight portion 11A to the opposite end in order to ease hole formation by casting.

On the other hand, to ease hole formation by casting, the complete-circular section core pin 12 also has a tapered shape in such a manner that the cross sectional area gradually increases from an end to the other end.

As illustrated in FIG. 4, a longer diameter direction of the oval cross section of the core pin 11 is oriented toward a direction connecting the center axes of the first bolt insertion hole 5 and the second bolt insertion hole 6, and an end face of the straight portion 11A and an end face of the complete-circular section core pin 12 having a minimum cross sectional area are coaxially disposed to be opposed to each other with a slight gap therebetween. In this manner, the front housing 101 is casted.

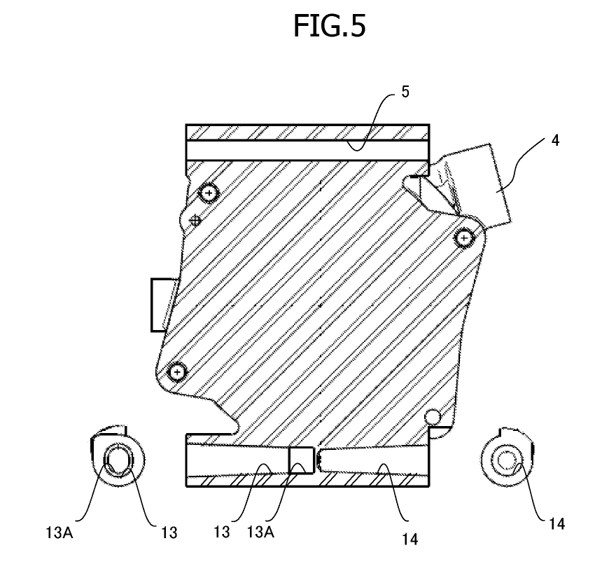

In the manner described above, after casting the two core pins 11 and 12, two through holes 13 and 14 corresponding to the sectional shapes of the core pins 11 and 12 are formed as illustrated in FIG. 5.

Here, a shorter diameter D_{S} of the oval cross section of the straight hole 13A corresponding to the straight portion 11A of the core pin 11 is equal to a diameter D₁ of the first bolt insertion hole 5.

On the other hand, a longer diameter D_{L} of the oval cross section is such a length that allows the bolt 8 to be screwed into the screw hole 10 with a reduced interference (contact friction resistance) with the second bolt insertion hole 6 depending on a dimensional error between a pitch between the first bolt insertion hole 5 and the second bolt insertion hole 6 and a pitch between the two screw holes 10 of the accessory attachment part 9 corresponding to the bolt insertion holes 5 and 6.

That is, suppose the dimensional error between the pitches is ±ΔL, the longer diameter D_{L} of the oval cross section satisfies a relationship of D_{L}>D₁+2ΔL.

The through hole 14 with the complete circular cross section corresponding to the complete-circular section core pin 12 has a diameter smaller than a longer diameter of the straight hole 13A of the through hole 13 near the end with the minimum cross sectional area, but has a diameter larger than the longer diameter near the bolt head portion.

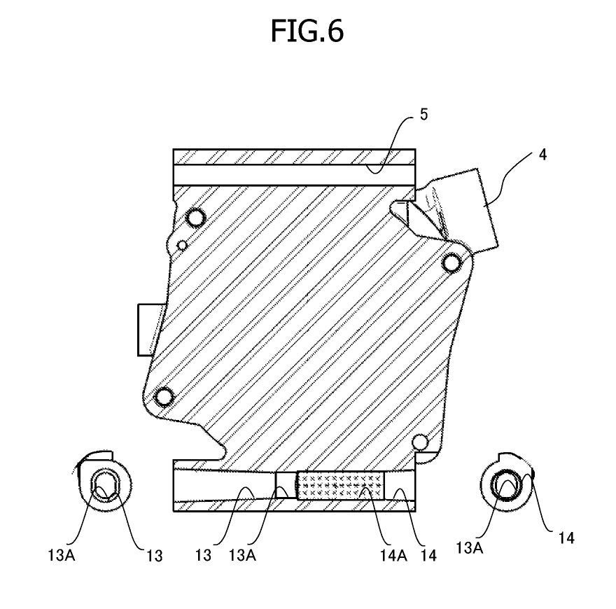

As described above, after the formation of the two through holes 13 and 14, a cutout hole 14A (indicated by hatching with X marks in FIG. 6) having a complete circular sectional shape with a diameter larger than the longer diameter of the straight hole 13A is drilled into the through hole 14 with the complete circular cross section until the tip of the cutout hole 14A reaches the straight hole 13A of the through hole 13.

In this manner, the diameter of the cutout hole 14A is larger than the longer diameter of the straight hole 13A so that an interference between the bolt 8 screwed into the screw hole 10 through the straight hole 13A and the cutout hole 14A can be avoided.

If two core pins are disposed with their front ends being in contact with each other, an interference occurs between opposing molds so that an excessive load might be applied to the core pins to induce damage on the core pins. In view of this, the core pins 11 and 12 need to be disposed with a gap interposed between the tips thereof. In this case, as illustrated in FIG. 5, casting fins are generated between the two through holes 13 and 14. In view of this, although a cutting process for penetrating the bolt insertion hole by removing such casting fins is necessary, this embodiment enables removal of the casting fins to be performed simultaneously with the single cutting process. Thus, the cutting process does not need to be performed additionally.

Then, the third bolt insertion hole 7 will be described. The third bolt insertion hole 7 is formed in such a manner that a bolt can be screwed into a screw hole with a reduced interference with the third bolt insertion hole, depending on a dimensional error between a pitch between the first bolt insertion hole 5 and the third bolt insertion hole 7 and a pitch between two screw holes 10 corresponding to the bolt insertion holes 5 and 7, and a dimensional error between a pitch between the second bolt insertion hole 6 and the third bolt insertion hole 7 and a pitch between two screw holes 10 corresponding to the bolt insertion holes 6 and 7. For example, suppose a larger one of these two dimensional error is ±ΔLₘₐₓ, the diameter D₃ of the third bolt insertion hole 7 satisfies a relationship of D₃>D₁+2ΔLₘₐₓ.

In a case where the bolts 8 are screwed into the screw holes 10 through the thus-formed three bolt insertion holes 5 to 7 and the compressor 100 is attached, for example, first, the three bolts 8 are screwed into the screw holes 10 through the corresponding ones of the first bolt insertion hole 5, the second bolt insertion hole 6, and the third bolt insertion hole 7 sequentially, are temporarily fixed, and then are further screwed to be firmly fixed.

As described above, the relative position of the first bolt insertion hole 5 to the engine body is accurately set with a minimum fitting gap.

The bolt 8 inserted into the second bolt insertion hole 6 is screwed into the screw hole 10 through a hole portion with the complete circular cross section sufficiently larger than the diameter of the bolt 8 and through the straight portion 11A having the minimum cross sectional area.

In this case, since the longer diameter of the oval cross section of the straight portion 11A has a length depending on the dimensional error between the pitches and the diameter of the hole portion with the complete circular cross section is larger than the longer diameter of the oval cross section, the bolt 8 can be smoothly screwed into the screw hole with a reduced interference with the second bolt insertion hole 6.

On the other hand, since the shorter diameter of the oval cross section of the straight portion 11A is equal to the diameter of the first bolt insertion hole 5, movement of the bolt 8 along the direction of the shorter diameter is restricted within the minimum fitting gap.

In this manner, the two bolts 8 are screwed into the screw holes 10 through the first bolt insertion hole 5 and the second bolt insertion hole 6 so that the compressor 100 can be attached to the engine body at an accurate position.

Since the third bolt insertion hole 7 has the complete circular cross section with a diameter depending on the dimensional errors between the pitches, the bolt 8 can be smoothly screwed into the screw hole 10 with an interference with the third bolt insertion hole 7 being avoided. The screwing with the three bolts 8 through those three bolt insertion holes enables the compressor 100 to be stably supported.

In the foregoing manner, the pulley 2 of the compressor 100 can be disposed at an appropriate position relative to the engine body, and thus, detachment of the belt 3 and abrasion at one side can be favorably suppressed.

In the second bolt insertion hole 6, the straight hole 13A for restricting the position of the bolt 8 is closer to the screw hole 10 than an axially intermediate position of the second bolt insertion hole 6. Thus, misalignment of the bolt 8 can be suppressed so that the positional accuracy in attaching the compressor 100 can be more favorably maintained.

In addition, since the first bolt insertion hole 5 and (the straight hole 13A) of the second bolt insertion hole 6 restrict movement of the compressor 100 within the minimum fitting gap relative to two directions that are orthogonal to each other, displacement of the compressor 100 due to vibrations of the engine, for example, can be favorably suppressed.

Furthermore, as compared to a conventional technique, in machining the second bolt insertion hole 6 having the oval cross section for accurately positioning the compressor 100 as described above, the present invention has significant advantages as follows.

Specifically, to form a bolt insertion hole in a hole having an oval cross section over the entire length (e.g., about 70 mm), the bolt insertion hole in the overall length is cut with an end mill in a conventional technique.

This cutting process with the end mill needs facilities such as a machining center and takes a long machining time and increased machining costs, as compared to machining of a hole with a complete circular cross section that can be formed with a drilling single-function machine.

In addition, the processing with the end mill needs the use of a cutter with an extension longer than the entire length of a bolt insertion hole, and the diameter and straightness of the hole vary because of vibrations of the cutter and a cutting resistance in machining so that the hole diameter substantially decreases. Consequently, in inserting a bolt, a resistance due to frictional contact between the inner surface of the hole and the bolt might cause a failure in generating an appropriate axial force with respect to a bolt fastening torque.

In addition, even in the case of forming a hole having an oval cross section by casting using a single core pin, a taper angle (hole formation gradient) of 1.5 degrees or more is needed to ease the hole formation as described above. Thus, it is difficult to obtain a necessary diameter in the entire length.

On the other hand, as a significant feature, the present invention provides the configuration in which the second bolt insertion hole 6 is divided into the hole portion with the oval sectional shape and the hole portion with the complete circular sectional shape. With this configuration, the hole with the oval sectional shape can be formed with minimum processes without the necessity of formation of a bolt insertion hole along the entire length so that reduction of a machining time, reduction of a machining cost, and enhancement of a machining accuracy can be obtained.

The present invention is not limited to the automotive compressor described above, and is also applicable to any belt-driven attachment structure for an engine accessory.

### REFERENCE SYMBOL LIST

100 compressor
101 front housing
103 rear housing
1 driving shaft
2 pulley
3 belt
5 first bolt insertion hole
6 second bolt insertion hole
7 third bolt insertion hole
8 bolt
9 accessory attachment part
10 screw hole
11 core pin with oval cross section
11A straight portion
11B tapered portion
12 core pin with complete circular cross section
13 through hole with oval cross section
13A straight hole
14 through hole with complete circular cross section
14A cutout hole

1. An attachment structure for an engine accessory, the attachment structure being used for attaching an engine accessory configured to be driven with a belt by screwing bolts penetrating bolt insertion holes in the engine accessory into screw holes in an engine body, wherein
at least one of the bolt insertion holes has an oval sectional shape in a cross section perpendicular to an axial direction thereof in a hole portion near a corresponding one of the screw holes and has a complete circular sectional shape with a diameter greater than or equal to a longer diameter of the oval sectional shape in a hole portion continuous to the hole portion with the oval sectional shape and reaching a head portion of a corresponding one of the bolts.

2. The attachment structure for the engine accessory according to claim 1, wherein the hole portion with the oval sectional shape has a surface with a hole formed by casting, and
the hole portion with the complete circular sectional shape has a surface processed by cutting in at least a portion continuous to the hole portion with the oval sectional shape.

3. The attachment structure for the engine accessory according to claim 1, wherein the hole portion with the oval sectional shape is disposed closer to the engine body than an axially intermediate location of the bolt insertion hole.

4. The attachment structure for the engine accessory according to claim 1, wherein
the number of the bolt insertion holes is three or more,
a first bolt insertion hole has a minimum fitting gap with a corresponding one of the screw holes,
a second bolt insertion hole has a longer diameter in a pitch direction connecting the first bolt insertion hole and the second bolt insertion hole, and
the second bolt insertion hole includes a hole portion with the oval sectional shape having a shorter diameter substantially equal to a diameter of the first bolt insertion hole.

5. The attachment structure for the engine accessory according to claim 4, wherein the longer diameter of the oval sectional shape of the second bolt insertion hole has such a length that allows a corresponding one of the bolts to be screwed into a corresponding one of the screw holes with a reduced interference with the second bolt insertion hole, depending on an inter-pitch dimensional error between a pitch between the first bolt insertion hole and the second bolt insertion hole and a pitch between two of the screw holes corresponding to the first and second bolt insertion holes.

6. The attachment structure for the engine accessory according to claim 4, wherein the other bolt insertion holes except the first bolt insertion hole and the second bolt insertion hole is a hole having a complete circular sectional shape with such a diameter that allows a corresponding one of the bolts to be screwed into a corresponding one of the screw holes with a reduced interference with the other bolt insertion hole, depending on a dimensional error between a pitch between the other insertion hole and each of the first bolt insertion hole and the second bolt insertion hole and a pitch between corresponding ones of the screw holes in the engine body.

7. The attachment structure for the engine accessory according to claim 1, wherein the engine accessory is a compressor for an automotive air conditioner.
